(19) United States
(12) Patent Application Publication
(10) Pub. No.: US 2014/0137896 A1
(43) Pub. Date: May 22, 2014

(54) WASHING DEVICE

(71) Applicants: Barry Margolis, Mountville, PA (US); Burton N. Margolis, Lancaster, PA (US)

(72) Inventors: Barry Margolis, Mountville, PA (US); Burton N. Margolis, Lancaster, PA (US)

(21) Appl. No.: 14/073,701

(22) Filed: Nov. 6, 2013

Related U.S. Application Data
(60) Provisional application No. 61/722,827, filed on Nov. 6, 2012.

(51) Int. Cl. B08B 9/32

(52) U.S. Cl. CPC B08B 9/32
USPC 134/22.18; 134/80; 134/142; 134/132; 134/124; 134/140

(57) ABSTRACT

A washing device that may include a conveyor frame having a carousel shape with a plurality of carrier sections along an outside section of the conveyor frame. The conveyor frame may rotate to transport at least one object through at least one processing station along a circular path. A first processing station may be positioned along the circular path. In certain embodiments, a second processing station may be positioned further along the circular path. The processing stations may include a washing station and a drying station. The object may be a tote container.

### CROSS-REFERENCE TO RELATED APPLICATION

This application claims the benefit of U.S. provisional application number 61/722,827, filed Nov. 6, 2012, the contents of which are herein incorporated by reference.

### BACKGROUND OF THE INVENTION

The present invention relates to industrial washers and, more particularly, to a device for washing tote containers.

Tote containers, and more specifically plastic tote containers, are widely used in commerce because they allow bulk items to be shipped in various quantities, and are durable, reusable, and stackable and come in standard sizes and uniform shapes. Because the receiver of a tote container of products may use the same tote container for shipping different products, it is common for a shipping tote container to carry a wide variety of products. Some of these products may be dry and benign, while others may be wet or potentially dangerous. Thus, it is necessary to periodically clean and sanitize these totes between uses.

Currently, however, industrial tote washers are expensive to purchase and maintain, and require a considerable amount of floor space. As a result, many companies simply wash and sanitize totes by hand, which is time and labor intensive, messy, and typically not as effective as machine washing.

As can be seen, there is a need for a device for washing large quantities of tote containers which can be used with a variety of different sized totes, and requires a limited amount of floor space and minimal operator assistance.

### SUMMARY OF THE INVENTION

In one aspect of the present invention, a washing device comprises: a conveyor frame having a carousel shape with a plurality of carrier sections along an outside section of the conveyor frame, wherein the conveyor frame rotates to transport at least object through at least one processing station along a circular path; and a first processing station positioned along the circular path.

In another aspect of the present invention, a method of washing and drying tote containers comprises: placing at least one tote container opened downward on one of a plurality of carrier sections of a washing device comprising a conveyor frame having a carousel shape with the plurality of carrier sections along an outside section of the conveyor frame, wherein the conveyor frame rotates to transport at least one tote container through at least one processing station along a circular path; wherein the at least one processing station comprises a washing station comprising a basin, a drain grate, at least one spray nozzle, a spray nozzle bar, a plurality of shields and a pump, wherein the pump is positioned outside of the conveyor frame area and a drying station comprising a dryer stand approximately situated near the conveyor frame and at least one dryer unit positioned over an area exposed along the circular path of the conveyor frame; adjusting the controller to power on the electricity for a motor that powers the conveyor frame, the at least one dryer unit to start blowing and the pump to supply water for the washing station; cycling the at least one tote container through the washing station and the drying station; and removing the at least one tote container from the washing device.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a detail exploded view of an exemplary embodiment of the present invention;

FIG. 3 is a section detail view of an exemplary embodiment of the invention along line 3-3 in FIG. 1;

FIG. 4 is a front detail view of an exemplary embodiment of the present invention demonstrating a blower blowing on an exemplary tote; and

FIG. 5 is a top view of an exemplary embodiment of a controller of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a washing device that may include a conveyor frame having a carousel shape with a plurality of carrier sections along an outside section of the conveyor frame. The conveyor frame may rotate to transport at least one object through at least one processing station along a circular path. A first processing station may be positioned along the circular path. In certain embodiments, a second processing station may be positioned further along the circular path. The processing stations may include a washing station and a drying station. The object may be a tote container.

The present invention may include a conveyor frame that rotates along a circular path and that transports tote containers or other objects through various processing stations. When a tote container has travelled one full rotation it may be clean and mostly dry, and ready for use.

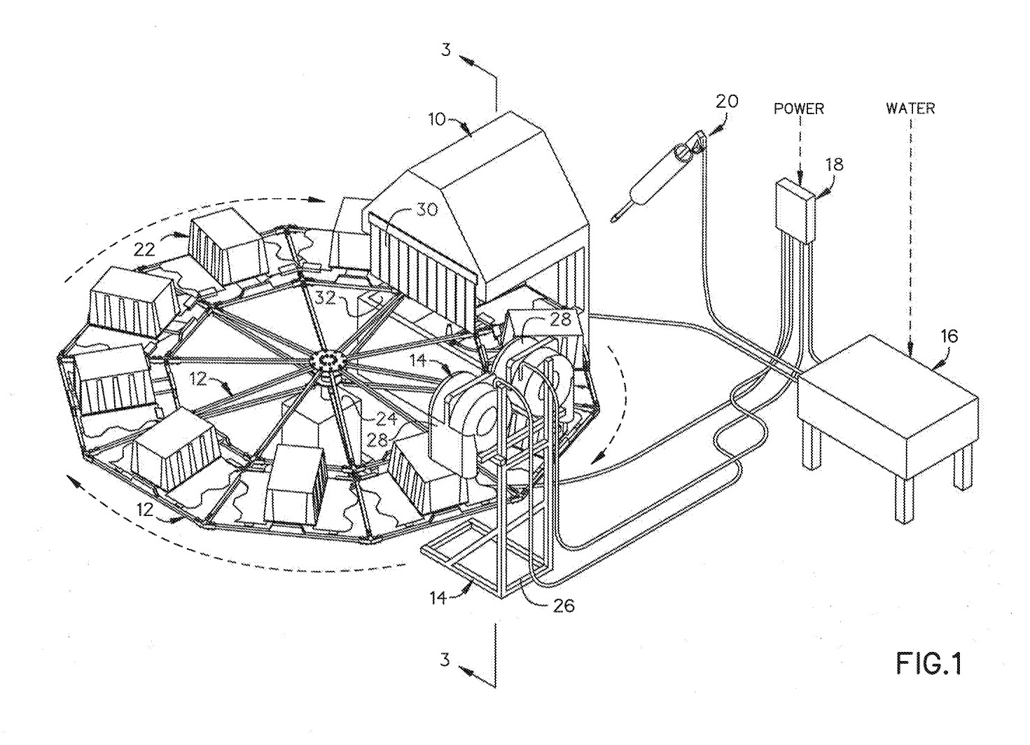

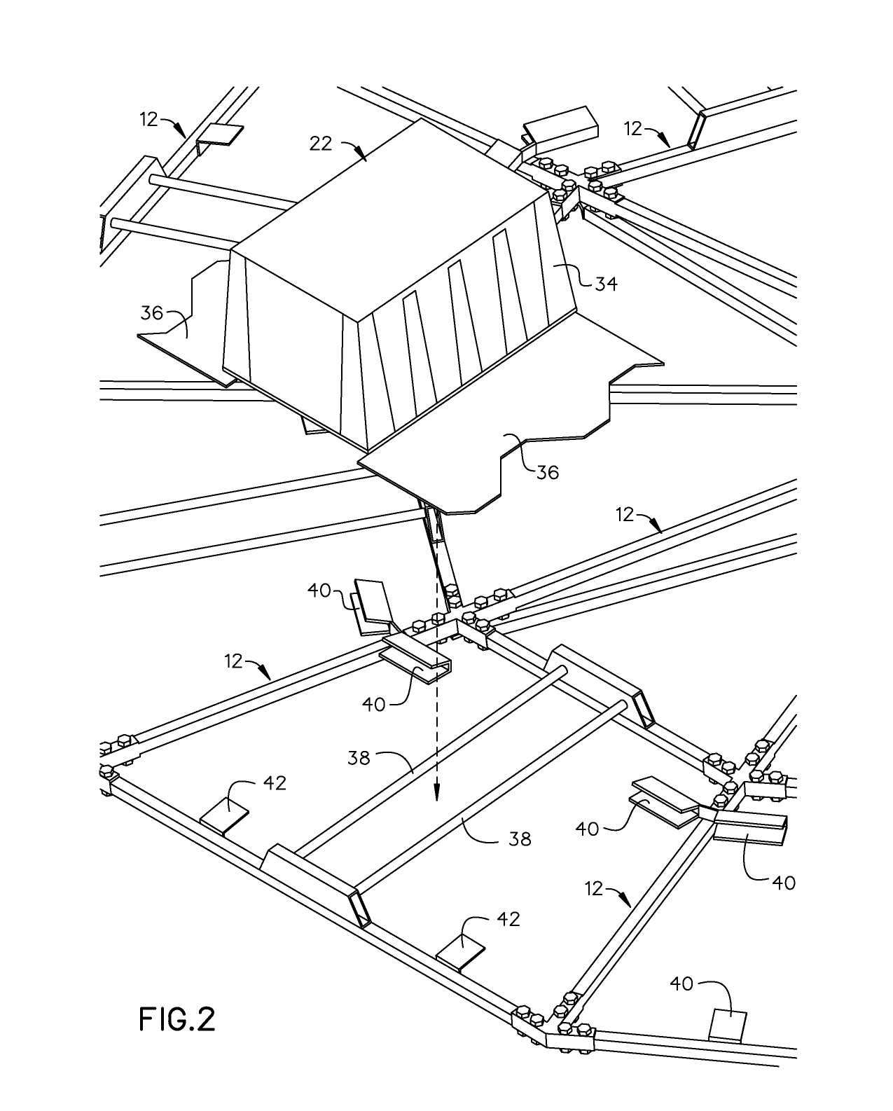

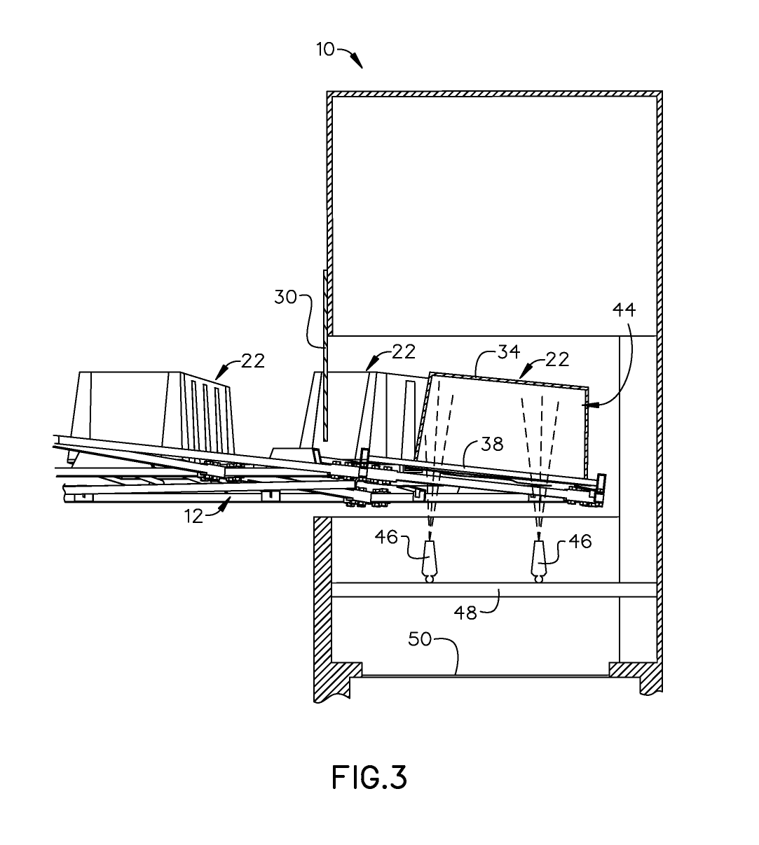

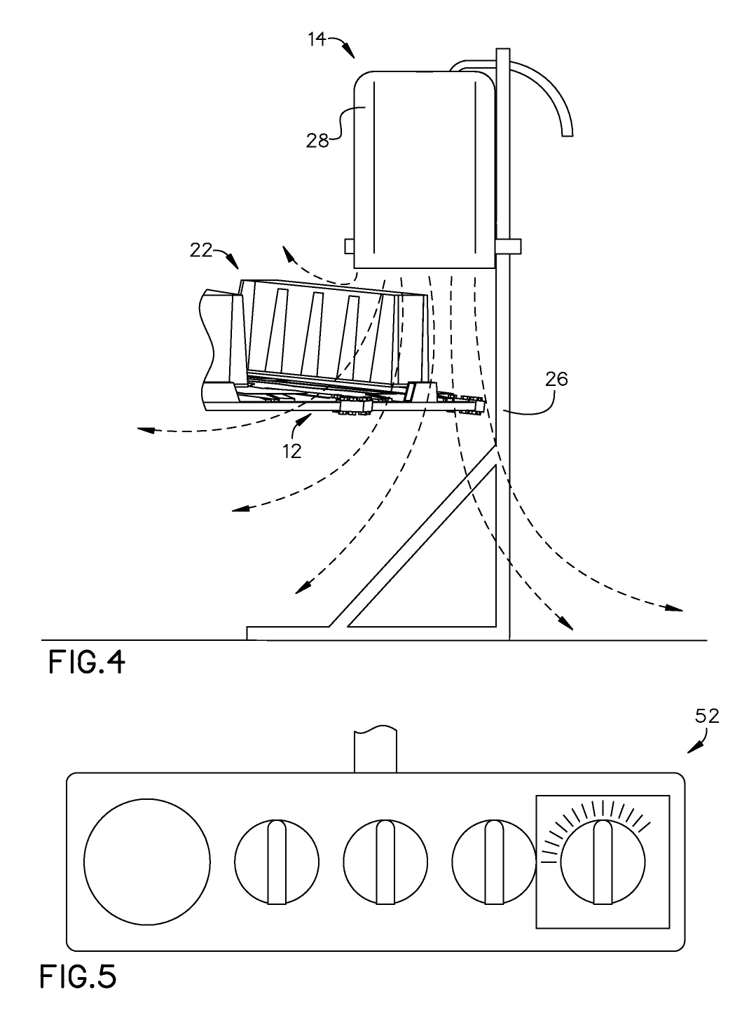

As is illustrated in FIGS. 1 through 4, the washing device may include a conveyor frame 12. The conveyor frame 12 may rotate along a circular path. The conveyor frame 12 may transport at least object through at least one processing station along the circular path. In certain embodiments, the conveyor frame 12 may have a carousel shape with a plurality of carrier sections 13 around an outside section 15 of the conveyor frame 12.

In certain embodiments, the at least one object may be at least one tote container 22. The at least one tote container 22 may include a body 34 having a top section, an interior housing 44 and at least one flap 36 attached to the top section of the body 34. In certain embodiments, each carrier section 13 of the conveyor frame 12 may include components that allow for the secure passage of the at least one tote container 22 while on the conveyor frame 12. A plurality of tote body support bars 38 may be positioned perpendicular to the movement of the conveyor frame 12. At least one tote flap retention channel 40 may be attached to the carrier section 13 of the conveyor frame 12. The at least one tote flap retention channel 40 may engage with the at least one flap 36 of the at least one tote container 22. At least one flap support tab 42 may also be attached to the carrier section 13 of the conveyor frame 12. The at least one flap support tab 42 may be attached to the carrier section 13 of the conveyor frame 12 so that it may help to maintain the position of the at least one flap 36 of the at least one tote container 22.

In certain embodiments, the conveyor frame 12 may be powered through a motor 24 which may be located below and in the middle of the conveyor frame 12. The motor 24 may be powered by a potentiometer and AC drive unit. This may allow for variable speed for varying factors, including the size of the object being transported, the amount of dirt to be removed, the speed of the operator and the like. In alternate embodiments, the conveyor frame 12 may be rotated manually or the like. The motor 24 may receive power through a connection with an electrical box 18. The electrical box 18 may provide electricity to the components that require electrical power throughout the washing device. The electrical box 18 may be a damp environment box which may be wall mounted The controls for a pump, the at least one dryer unit 28 and the AC drive unit and relays. A pump may be used to supply water. The pump may be enclosed inside a pump box 16. The power for the pump may be from the electrical box 18.

In certain embodiments, a first processing station may be a washing station 10. The washing station 10 may include a drain grate 50 and at least one spray nozzle 46. The at least one spray nozzle 46 may be attached to a spray nozzle bar 48. The drain grate 50, the at least one spray nozzle 46 and spray nozzle bar 48 may all be placed below the conveyor frame 12 as part of a washing station basin 32. Along and above the level of the conveyer frame 12 may be a plurality of shields 30. The plurality of shields 30 may be made from rubber or the like. The at least one spray nozzle 46 may spray water into the interior housing 44 of the at least one tote container 22. The water being sprayed into the interior housing 44 of the at least one tote container 22 may be provided from the pump enclosed in the pump box 16. In certain embodiments, a separate handheld wash unit 20 may be provided in the case that the washing may be completed manually.

In certain embodiments, the pump, possibly electric, having 1 or 2 phases may supply water to the at least one spray nozzle 46. The pump may be powered by 209/230 1 phase, 230/460-240/480 3 phase electric motors or the like. They could also be powered by gas or diesel engines. The pump itself may vary in gallons per minute and pressure up to the motor's capability. The pump may be capable of pumping supplied water up to 190 degrees. A solenoid valve may be available to shut off and on the water coming to the pump. This is activated with the same switch that may operate the pump itself. A pressure relief valve may be attached to the pump to avoid hoses bursting in the event of restrictions in high pressure lines. A pressure washer may be installed if the option of a separate hose and gun is chosen.

In certain embodiments, a second processing station may be a drying station 14. The drying station 14 may include a dryer stand 26 and at least one dryer unit 28. The dryer stand 26 may be approximately situated near the conveyor frame 12 so that the dryer stand 26 may position the at least one dryer unit 28 over the at least object moving along the conveyor frame 12. The least one dryer unit 28 may be positioned over an area exposed along the circular path of the conveyor frame 12. The at least one dryer 28 unit may be multi-speed. In certain embodiments, the at least one dryer unit 28 may be three speed.

In certain embodiments, the control over the rotation of the conveyor frame 12 may be from a controller 52. In certain embodiments, the conveyor frame 12 may be a chain conveyor, a screw conveyor, a belt conveyor, a bucket conveyor, a gravity conveyor, a roller conveyor, a spiral conveyor, a slip conveyor, a chain driven live roller conveyor or the like.

A method of using the washing device may include placing at least one tote container 22 opened downward onto the carrier section 13 of the conveyor frame 12. The plurality of tote body support bars 38 may be positioned to keep the at least one tote container 22 in place. The at least one tote flap retention channel 40 may be removably attached to the at least one flap 36 of the at least one tote container 22. The at least one flap support tab 42 may positioned so as to hold the at least one flap 36 in place while the at least one tote container 22 may be in transport. The power to all the components may be turned on so that the conveyor frame 12 rotates, the at least one dryer unit 28 starts blowing and the pump starts supplying water to the washing station 10. Once the at least one tote container 22 may be positioned within the washing station 10, the interior housing 44 of the at least one tote container 22 may be cleaned with the water from the at least one spray nozzle 46. The at least one tote container 22 may then pass through to the drying station 14 where the at least one tote container 22 may pass underneath the at least one dryer unit 28 so that the air may blow over the at least one tote container 22, thereby drying the at least one tote container 22 in the process.

It should be understood, of course, that the foregoing relates to exemplary embodiments of the invention and that modifications may be made without departing from the spirit and scope of the invention as set forth in the following claims.

What is claimed is:

1. A washing device comprising:
a conveyor frame having a carousel shape with a plurality of carrier sections along an outside section of the conveyor frame, wherein the conveyor frame rotates to transport at least object through at least one processing station along a circular path; and
a first processing station positioned along the circular path.

2. The washing device of claim 1, wherein the first processing station comprises a washing station positioned along the circular path.

3. The washing device of claim 2, wherein the washing station further comprises a basin, a drain grate, at least one spray nozzle, a spray nozzle bar, a plurality of shields and a pump, wherein the pump is positioned outside of the conveyor frame area.

4. The washing device of claim 3, wherein the pump is powered through an electrical box.

5. The washing device of claim 1, further comprising a second processing station positioned along the circular path.

6. The washing device of claim 5, wherein the second processing station comprises a drying station positioned along the circular path.

7. The washing device of claim 6, wherein the drying station comprises a dryer assembly.

8. The washing device of claim 7, wherein the dryer assembly comprises a dryer stand approximately situated near the conveyor frame and at least one dryer unit positioned over an area exposed along the circular path of the conveyor frame.

9. The washing device of claim 8, wherein the at least one dryer unit is powered through the electrical box.

10. The washing device of claim 1, wherein the conveyor frame is powered by an automation mechanism.

11. The washing device of claim 10, wherein the automation mechanism comprises a controller, an electrical box, and a motor.

12. The washing device of claim 1, wherein the at least object is at least one tote container having a body and at least one flap.

13. The washing device of claim 12, wherein the carrier section comprises a plurality of tote body support bars positioned perpendicular to the movement of the conveyor frame, at least one tote flap retention channel engaging with the at least one flap of the at least one tote container, and at least one tote flap support tab maintaining the position of the at least one flap.

14. The washing device of claim 2, further comprising a handheld wash unit accessible to the washing station positioned along the circular path.

15. The washing device of claim 1, wherein the conveyor frame comprises a conveyor frame selected from the group consisting of a chain conveyor, a screw conveyor, a belt conveyor, a bucket conveyor, a gravity conveyor a roller conveyor, a spiral conveyor, a slip roller conveyor and a chain driven live roller conveyor.

16. A method of washing and drying tote containers comprising:
placing at least one tote container opened downward on one of a plurality of carrier sections of a washing device comprising a conveyor frame having a carousel shape with the plurality of carrier sections along an outside section of the conveyor frame, wherein the conveyor frame rotates to transport at least one tote container through at least one processing station along a circular path; wherein the at least one processing station comprises a washing station comprising a basin, a drain grate, at least one spray nozzle, a spray nozzle bar, a plurality of shields and a pump, wherein the pump is positioned outside of the conveyor frame area and a drying station comprising a dryer stand approximately situated near the conveyor frame and at least one dryer unit positioned over an area exposed along the circular path of the conveyor frame;
adjusting the controller to power on the electricity for a motor that powers the conveyor frame, the at least one dryer unit to start blowing and the pump to supply water for the washing station;
cycling the at least one tote container through the washing station and the drying station; and
removing the at least one tote container from the washing device.
